(19) United States
(12) Patent Application Publication
(10) Pub. No.: US 2017/0225311 A1
(43) Pub. Date: Aug. 10, 2017

(54) STAPLER

(71) Applicant: APEX MFG. CO., LTD., Taichung City (TW)

(72) Inventor: Rong-Yu WANG, Taichung City (TW)

(21) Appl. No.: 15/016,706

(22) Filed: Feb. 5, 2016

(51) Int. Cl. B25C 5/16; B25C 5/11

(52) U.S. Cl. CPC B25C 5/16; B25C 5/11

(57) ABSTRACT

A stapler includes a main body, a magazine, a striker, and a driving portion. The main body encloses a receiving space and has an opening at the bottom of the front end thereof The opening communicates with the receiving space. The magazine is arranged in the main body for receiving nails. The striker is arranged at the front end of the main body and is linearly slidable above the opening vertically. The driving portion is disposed on the main body and is connected to the striker to drive it to move downward to strike the nail out. The striker has a bottom face oriented frontward and downward so that an angle ranged from 3-15 degrees is defined between the bottom face and the horizontal plane.

### BACKGROUND OF THE INVENTION

Field of the Invention

The present invention relates to a stapler.

Description of the Prior Art

A conventional stapler includes a main body, a magazine, a striker, and a driving portion, such as a pressing arm or a trigger. The magazine is received in the main body for receiving nails. The striker is located at a front end of the main body and is linearly movable along a vertical direction. The driving portion is engaged with the striker to drive the striker to move downward to strike nails out.

The conventional magazine has an elastic element to push the nails frontward, but the elasticity can not be too strong to result the failure of striking. However, it also results that the first nail lacks of enough elastic force so they the lower end of the nail tends to move backward when the nail is hit by the striker. Thus, the nail may be inclined so that it becomes difficult to strike the nail out successfully. Therefore, the efficiency of working is reduced, and the nails and the components of the stapler may be abraded.

### SUMMARY OF THE INVENTION

The main object of the present invention is to provide a stapler which reduces failures of striking.

To achieve the above and other objects, the stapler of the present invention includes a main body, a magazine, a striker, and a driving portion.

The main body encloses a receiving space and has an opening at a lower part of a front end thereof The receiving space communicates with the opening. The magazine is arranged in the receiving space of the main body and is adapted for receiving a plurality of nails. The striker is disposed on the front end of the main body and is linearly slidable above the opening along a vertical direction. The driving portion is disposed in the main body and is connected to the striker for driving the striker to move downward to strike the nails out. The striker has a bottom face at a bottom end thereof The bottom face is oriented toward the front end of the main body and downward so that an angle is defined between the bottom face and a horizontal plane. The angle is ranged from 3 degrees to 15 degrees.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial stereogram of the present invention;

FIG. 2 is an illustration of the present invention;

FIG. 3 is a profile of the present invention when a nail has not been stroke out;

FIG. 3A is a partial enlargement of FIG. 3;

FIG. 4 is a profile of the present invention when a nail is stroke out;

FIG. 4A is a partial enlargement of FIG. 4;

FIG. 5 is a partial profile of the present invention.

### DETAILED DESCRIPTION OF THE PREFERRED EMBODIMENTS

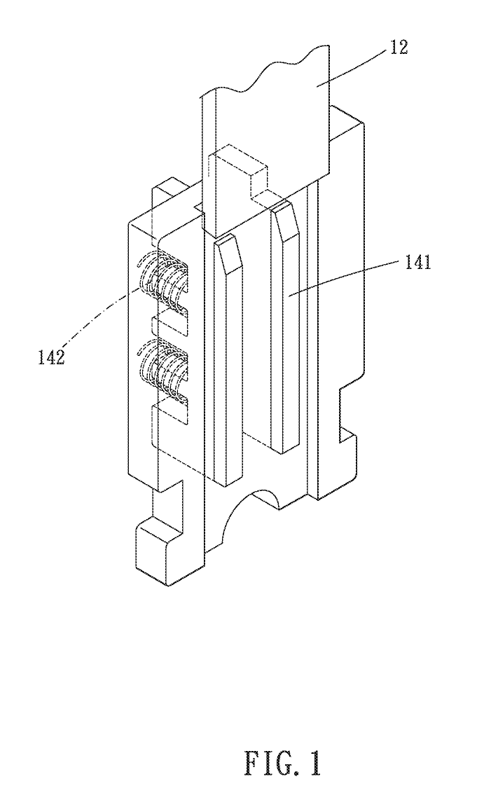

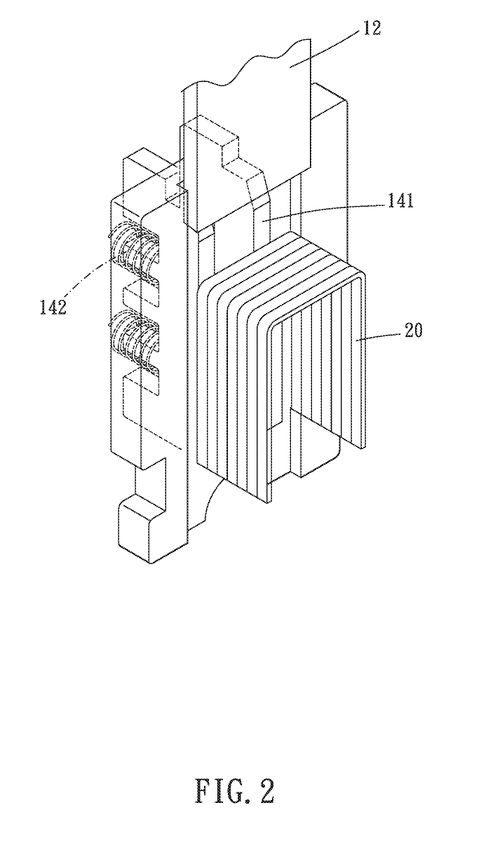

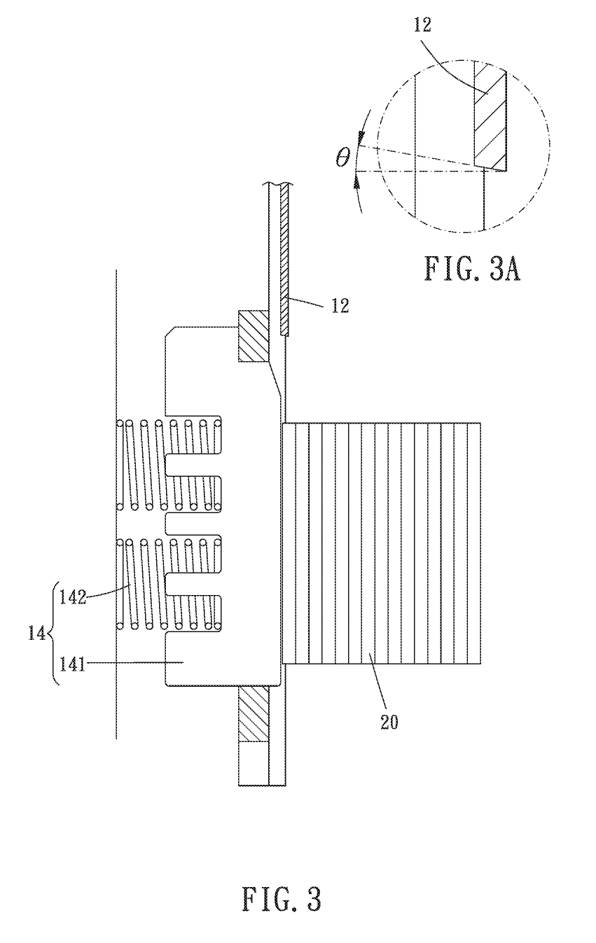

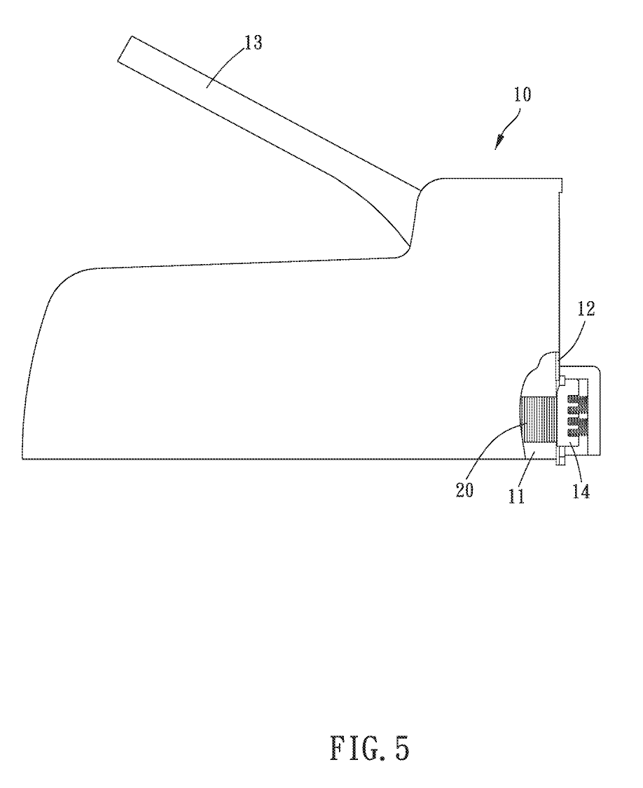

Please refer to FIGS. 1 to 5, 3A, and 4A, the stapler of the present invention includes a main body 10, a magazine 11, a striker 12, and a driving portion 13.

The main body 10 encloses a receiving space and has an opening at a lower part of a front end thereof The receiving space communicates with the opening. The magazine 11 is received in the main body 10 for receiving nails 20. The striker 12 is arranged at the front end of the main body 10 and is linearly slidable above the opening along a vertical direction. The driving portion 13 is disposed on the main body 10 and is connected to the striker 12 to drive the striker 12 to move downward to strike the nails out. In the present embodiment, the driving portion 13 includes a pressing arm above the main body 10. Specifically, the striker 12 has a bottom face at a bottom end thereof The bottom face is oriented toward the front end of the main body 10 and downward so that an angle is defined between the bottom face and a horizontal plane. The angle is ranged from 3 degrees to 15 degrees. In addition, the lower portion of the bottom face of the striker 12 corresponds to a rear portion of the nail 20 to be stroke out.

In the present embodiment, a blocking structure 14 is also included. The blocking structure 14 includes an elastic element 142 and a blocking element 141. The blocking element 141 is located in front of the magazine 11 and the striker 12. The elastic element 142 is biased between the blocking element 141 and the front end of the main body 10 so that the blocking element 141 tends to move toward the magazine 11 to correspond to nails in different sizes and shapes.

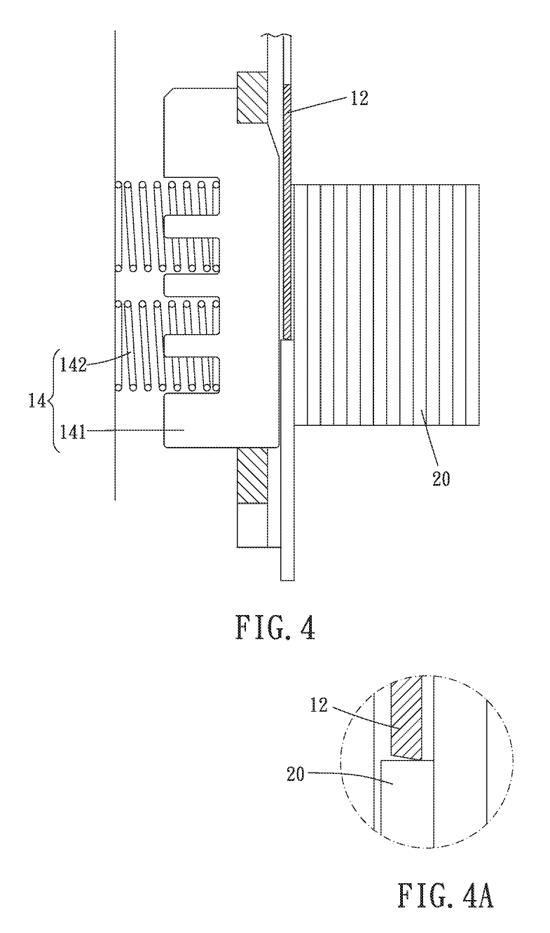

In conclusion, the striker 12 of the present invention has an inclined bottom face, so only the lower end of the striker 12 touches the rear portion of the nail 20 at the beginning so that the nail 20 receives a force clockwise (in FIGS. 4 and 4A). When the bottom face of the striker 12 further contacts the nail 20, the striker 12 continuously provides the force clockwise to the nail 20 to make the nail 20 move along the blocking element 141. Thus, the nail 20 can be stroke out along the blocking element 141 to prevent from failure of striking.

What is claimed is:

1. A stapler, including:
a main body, enclosing a receiving space, having an opening at a lower part of a front end thereof, the receiving space communicating with the opening;
a magazine, arranged in the receiving space of the main body, adapted for receiving a plurality of nails;
a striker, disposed on the front end of the main body, being linearly slidable above the opening along a vertical direction;
an driving portion, disposed in the main body and connected to the striker, adapted for driving the striker to move downward to strike the nails out;
wherein the striker has a bottom face at a bottom end thereof, the bottom face is oriented toward the front end of the main body and downward so that an angle is defined between the bottom face and a horizontal plane, the angle is ranged from 3 degrees to 15 degrees.

2. The stapler of claim 1, wherein the driving portion includes a pressing arm located above the main body.

3. The stapler of claim 1, further including a blocking structure, the blocking structure including an elastic element and a blocking element, the blocking element being disposed in front of the magazine and the striker, the elastic element being biased between the blocking element and the front end of main body so that the blocking element tends to move toward the magazine, the blocking structure being adapted for corresponding to nails in different sizes and shapes.

4. The stapler of claim 1, wherein a lowest portion of the bottom face of the striker corresponds to a rear portion of a nail to be stroke out.
